(19) United States
(12) Patent Application Publication
(10) Pub. No.: US 2012/0131076 A1
(43) Pub. Date: May 24, 2012

(54) FILE SHARING METHOD AND FILE SHARING SYSTEM UTILIZING THE SAME

(75) Inventors: Johnny Chen, Santa Ana, CA (US); Gary Kung, Santa Ana, CA (US)

(73) Assignee: I O INTERCONNECT, LTD., Santa Ana, CA (US)

(21) Appl. No.: 13/305,732

(22) Filed: Nov. 28, 2011

Related U.S. Application Data
(63) Continuation-in-part of application No. 13/052,044, filed on Mar. 18, 2011.
(60) Provisional application No. 61/416,289, filed on Nov. 22, 2010.

(51) Int. Cl. G06F 17/30; H04W 8/00; G06F 15/16

(52) U.S. Cl. 707/827; 707/E17.005; 707/E17.01

(57) ABSTRACT

An electronic device in a file sharing system includes a processor, a short distance communication controller and a transceiver module. The processor identifies a peer electronic device in the file sharing system based on an authentication message carrying information pertinent to identity of the peer electronic device and obtains information pertinent to one or more file(s) stored in a storage device. The short distance communication controller receives the authentication message. The transceiver module transmits the information pertinent to the file(s) to the identified peer electronic device.

### CROSS REFERENCE TO RELATED APPLICATIONS

This application claims the benefit of U.S. Provisional Application No. 61/416,289, filed on Nov. 22, 2010 and entitled “File sharing system and method”. This application is a continuation-in-part (CIP) of U.S. Patent Application entitled “File sharing method and file sharing system utilizing the same” Ser. No. 13/052,044 filed on Mar. 18, 2011. The entire contents of which are hereby incorporated by reference.

### BACKGROUND OF THE INVENTION

1. Field of the Invention

The invention relates to a file sharing system and method, and more particularly to a file sharing system and method with improved security and bandwidth efficiency.

2. Description of the Related Art

Electronic devices, such as personal computers, personal communication devices, personal digital assistants, laptop computers, tablet computers, or others, are commonly used currently, since they provide users with convenient voice and data communication and network access functions.

Conventionally, when using the electronic device to share a file with other user(s) in a local network, the electronic device user has to manually set up some security related fields of the file or folder, such as a user name and password, so as to give the right for other user(s) to access that file. However, once the password is intentionally deciphered by someone not given the right, security of the shared file cannot be protected anymore.

Therefore, a novel file sharing system and method with improved security and further with improved bandwidth efficiency is highly required.

### BRIEF SUMMARY OF THE INVENTION

Electronic devices in a file sharing system and file sharing methods are provided. An embodiment of an electronic device in a file sharing system comprises a processor, a short distance communication controller and a transceiver module. The processor identifies a peer electronic device in the file sharing system based on an authentication message carrying information pertinent to identity of the peer electronic device and obtains information pertinent to one or more file(s) stored in a storage device. The short distance communication controller receives the authentication message. The transceiver module transmits the information pertinent to the file(s) to the identified peer electronic device.

Another embodiment of an electronic device in a file sharing system comprises a processor, a short distance communication controller and a transceiver module. The processor identifies a peer electronic device in the file sharing system based on an authentication message carrying information pertinent to identity of the peer electronic device and obtains information pertinent to one or more file(s) stored in a storage device. The short distance communication controller receives the authentication message and transmits the information pertinent to the file(s) to the identified peer electronic device. The transceiver module transmits content of the file(s) to the identified peer electronic device.

Another embodiment of a file sharing method comprises: identifying, by an electronic device, identity of a peer electronic device in a file sharing system via a short distance connection established between the electronic device and the peer electronic device; obtaining, by the electronic device, information pertinent to a plurality of files stored in a storage device, wherein data size of the information is smaller than data size of the files; transmitting, by the electronic device, the information pertinent to the files to the identified peer electronic device; receiving, by the electronic device, information pertinent to one or more selected file(s) from the identified peer electronic device; accessing, by the electronic device, the storage device to obtain content of the selected file(s); and communicating, by the electronic device, with the identified peer electronic device so as to share the content of the selected file(s) with the identified peer electronic device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a storage device and an electronic device in a file sharing system according to an embodiment of the invention;

FIG. 2 shows exemplary sharing folders with some music, video or picture files moved therein by a user to share with among peers in a local area network according to an embodiment of the invention;

FIG. 3 shows an exemplary file sharing system comprising a plurality of electronic devices with files shared therebetween according to an embodiment of the invention;

FIG. 4 shows a message and data flow between a provider and a client according to an embodiment of the invention;

FIG. 5 shows a message flow between a provider and a client according to an embodiment of the invention;

FIG. 6 shows a flow chart of a file sharing method according to an embodiment of the invention;

FIG. 7 shows a message and data flow between a provider and a client according to another embodiment of the invention;

FIG. 8 shows a block diagram of an electronic device in a file sharing system according to another embodiment of the invention; and

FIG. 9 shows a flow chart of a file sharing method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

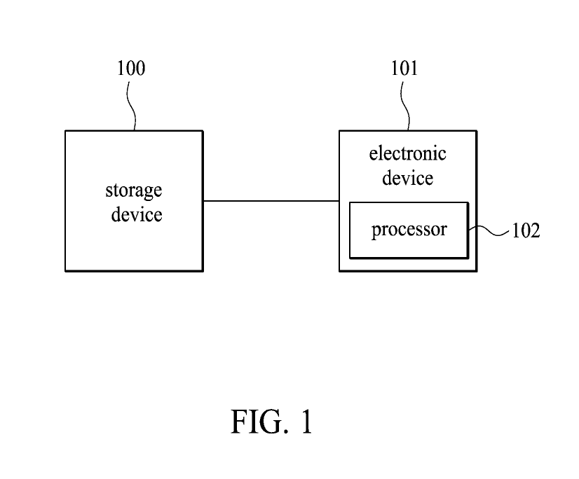

A file sharing method and a file sharing system comprising a plurality of electronic devices with files shared therebetween are presented. FIG. 1 shows a storage device 100 and an electronic device 101 in a file sharing system according to an embodiment of the invention. In the embodiment, the electronic device 101 with the storage device 100 coupled thereto may act as a provider in the file sharing system. Note that the electronic device may be a mobile phone, a personal computer, a tablet computer, or others, and the invention should not be limited thereto.

The storage device 100 stores a plurality of files, for example, but not limited to music, pictures, movies, or others. The storage device 100 may be an external storage device, such as an external hard disc device outside of the electronic device 101 as shown in FIG. 1. However, the storage device 100 may also be represented in other forms and the invention should not be limited thereto. For example, the storage device 100 may be represented as a USB dongle, a flash drive, or others. For another example, the storage device 100 may also be a built-in storage device configured inside of the electronic device 101, such as an internal hard disk, or others.

The connection between the electronic device 101 and the storage device 100 may be implemented in either a wired or wireless way, and the invention should not be limited thereto. For example, the storage device 100 may be connected to the electronic device 101 via a transmission line as shown. For another example, the storage device 100 and the electronic device 101 may be equipped with a wireless module, such as a WiFi/WiFi-direct/Bluetooth module, and may be connected to each other via the corresponding wireless module.

According to the embodiments of the invention, a file-sharing application program may be utilized to facilitate the file sharing procedure. By executing the file-sharing application program, it is easy for a user to share the files by just moving the files to be shared in assigned sharing folders, without manually setting up any security related fields for each file or folder as required in conventional design. In addition, only the devices having the file-sharing application program installed therein may be aware of the shared folders, so as to protect the security and integrity of the shared files.

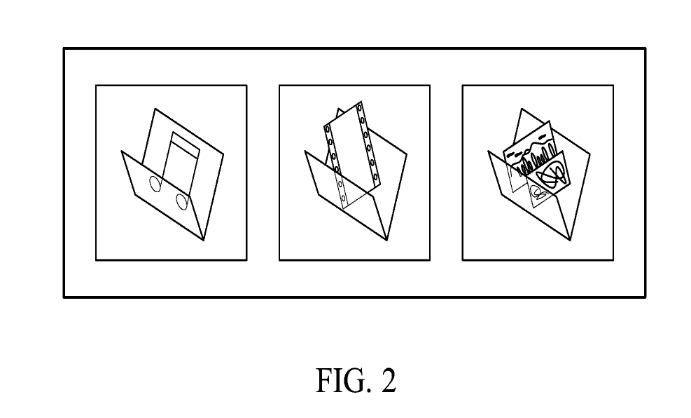

In some embodiments of the invention, the file-sharing application program may be installed in the storage device side. When the storage device 100 is connected to the electronic device 101, the file-sharing application program installed in the storage device 100 may be automatically started, and executed by a processor 102 of the electronic device 101. In the storage device 100, a plurality of assigned sharing folders may be created. The data or files that a user would like to share with other peers in a local area network may be moved into the assigned sharing folders. FIG. 2 shows exemplary sharing folders with some music, video or picture files moved therein by a user to share with among peers in a local area network according to an embodiment of the invention.

According to other embodiments of the invention, the file-sharing application program may also be installed in the electronic device side. When the electronic device 101 has detected that any storage device is connected thereto, the application program installed therein may be automatically started and executed by the processor 102 of the electronic device 101. The file-sharing application program may detect that whether there is any assigned sharing folder created in the storage device 100. If there is no assigned sharing folder created in the storage device 100, the sharing folders for containing the files that a user would like to share with other peers may be created by the electronic device 101. Note that according to yet other embodiments of the invention, the file-sharing application program may also be installed in the storage device side, and automatically started and executed by a processing unit of the storage device 100, and the invention should not be limited thereto.

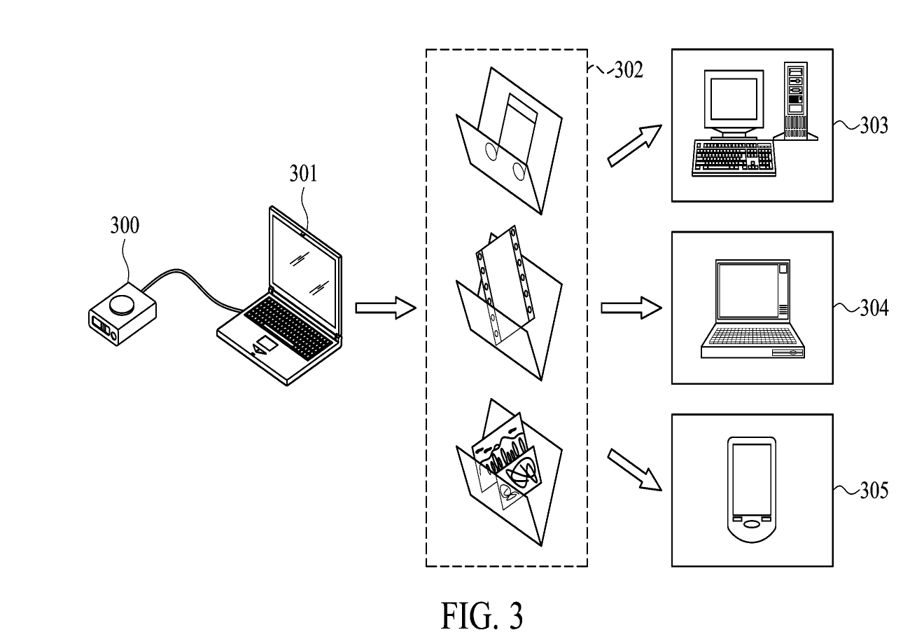

FIG. 3 shows an exemplary file sharing system comprising a plurality of electronic devices with files shared therebetween according to an embodiment of the invention. According to an embodiment of the invention, any peer electronic devices having the above-mentioned file-sharing application program installed therein, such as but not limited to the personal computer, notebook and mobile phone as shown, may join the file sharing system, and act as the clients for accessing the sharing folders. The file sharing procedures are illustrated in more detailed in the following paragraphs.

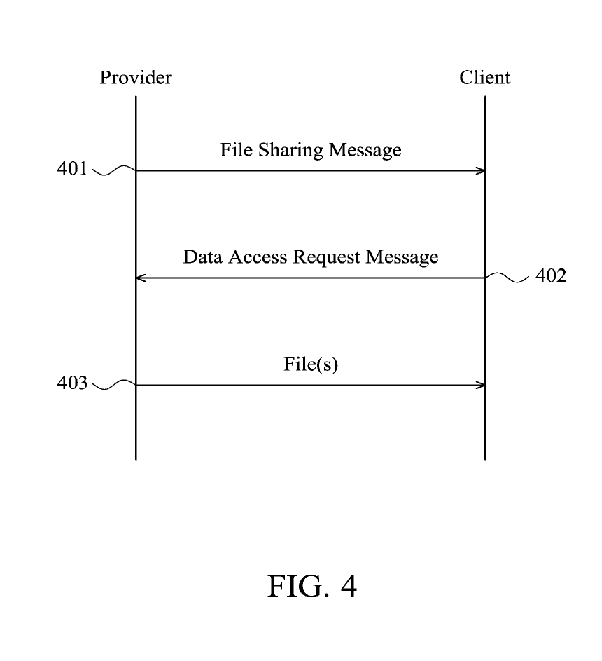

According to an embodiment of the invention, the electronic device 301 (hereinafter called the provider) may first obtain information 302 pertinent to the files stored in the assigned sharing folders, and actively share the information 302 to other peer electronic devices (hereinafter called the clients) in the local area network, such as electronic devices 303, 304 and/or 305 shown in FIG. 3. FIG. 4 shows a message and data flow between a provider and a client according to an embodiment of the invention. As shown in FIG. 4, the provider may transmit a file sharing message 401 comprising the information pertinent to the files stored in the assigned sharing folders to a predetermined network address in the local area network. According to an embodiment of the invention, the information pertinent to the files stored in the assigned sharing folders may comprise file names of the files, and/or directories of the assigned sharing folder(s).

Since only information pertinent to the files stored in the assigned sharing folders are carried in the file sharing message, the data size of the information carried in the file sharing message is much smaller than data size of the content of the files. Bandwidth efficiency has greatly improved.

When the clients having the file-sharing application program installed therein have received the file sharing message, the clients may determine or select one or more of the files which they would like to access based on the information carried in the file sharing message 401, and generate a data access request message 402 comprising the information pertinent to the one or more selected file(s). The data access request message 402 may be transmitted back to the provider. Upon receiving the data access request message 402, the provider may access the one or more selected file(s) in response to the data access request message 402, and communicate with the client so as to share the selected file(s) 403 with the client.

According to an embodiment of the invention, the provider may transmit the file sharing message 401 by broadcasting (i.e. one to all) the information in the local area network, so that all the clients having the file-sharing application program installed therein may receive the information. According to another embodiment of the invention, the provider may also transmit the file sharing message 401 by multicasting (i.e. one to many) the information to a group of clients having the file-sharing application program installed therein, so that the clients joining in the group may receive the information. According to yet another embodiment of the invention, the provider may also transmit the file sharing message 401 by unicasting (i.e. one to one) the information directly to a specific client having the file-sharing application program installed therein.

Upon receiving the file sharing message 401 carrying information pertinent to the directory of the assigned sharing folders and/or filenames of the files stored in the assigned sharing folders, the client having the file-sharing application program installed therein may establish a peer to peer connection, or a peer to peer group connection with the provider, and begin to access the files stored in the assigned sharing folders. In the following paragraphs, the detailed embodiments for broadcasting, multicasting, or unicasting the file sharing message 401 are introduced.

For the broadcasting case, according to an embodiment of the invention, the provider may transmit the file sharing message 401 to a predetermined broadcast address, such as 255.255.255.255. The clients in the same local area network and having the file-sharing application program installed therein may listen to the broadcast address and receive the file sharing message 401. The clients may further obtain the IP address of the provider from the file sharing message 401. Thereafter, the clients may establish a peer to peer connection, or a peer to peer group connection with the provider, and begin to access the files stored in the assigned sharing folders.

For the multicasting case, according to an embodiment of the invention, the provider may transmit the file sharing message 401 to one or more predetermined multicast addresses. For a predetermined multicast address, there may be a group corresponding thereto. Any devices located within the internet or the local area network and joined within a group may receive the message transmitted to the corresponding multicast address. The clients may further obtain the IP address of the provider from the received file sharing message 401. Thereafter, the clients may establish a peer to peer connection, or a peer to peer group connection with the provider, and begin to access the files stored in the assigned sharing folders. The information pertinent to the corresponding groups of predetermined multicast addresses may be transmitted to the clients in many ways.

For example, in one embodiment, the provider may first obtain the information pertinent to one or more multicast group(s) corresponding to predetermined multicast addresses, and broadcast a group information message 501 comprising the information pertinent to one or more multicast group(s) in the local area network before multicasting the file sharing message 401.

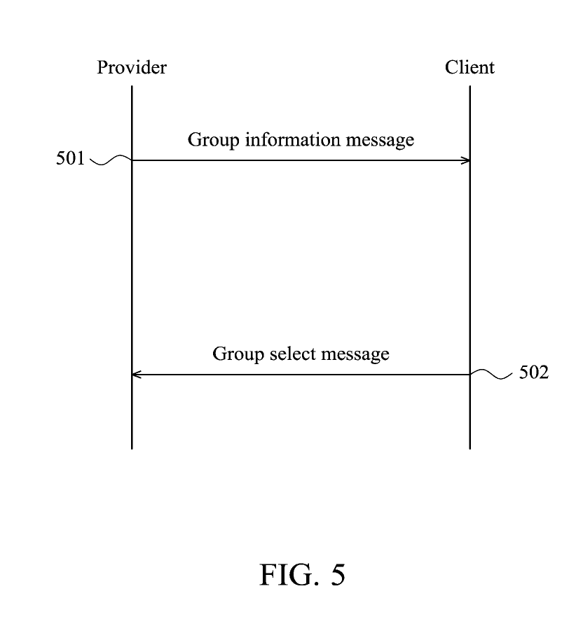

FIG. 5 shows the message flow between a provider and a client according to an embodiment of the invention. The clients in the same local area network and having the file-sharing application program installed therein may listen to the broadcast address and receive the group information message 501. In response to the group information message 501, the file-sharing application software may further facilitate the client to choose and join in with one group, so that the client can receive the messages transmitted to the corresponding multicast address. The client may transmit a group select message 502 comprising the information pertinent to the selected multicast group to the provider. In response to the group select message 502, the provider may join the client in the selected multicast group and transmit the file sharing message 401 to the multicast address corresponding to the selected multicast group.

For another example, in another embodiment, the multicast addresses and the corresponding groups may be predefined and hard coded in the file-sharing application program. In this manner, the file-sharing application program may facilitate the client to directly choose and join in with one group (that is, there is no need to listen to the broadcasted group information) so that the client may receive the file sharing message 401 transmitted to the corresponding multicast address.

For the unicasting case, according to an embodiment of the invention, the provider may directly unicast the file sharing message 401 to a specific client (for example, to an IP address of the client) having the file-sharing application program installed therein. Upon receiving the file sharing message 401, the client may further obtain the IP address of the provider from the received file sharing message 401. Thereafter, the client having the file-sharing application program installed therein may establish a peer to peer connection, or a peer to peer group connection with the provider, and begin to access the files stored in the assigned folders.

Referring back to FIG. 4, according to the embodiments of the invention, the data access request message 402 may also be transmitted to one or more provider(s) by broadcasting (i.e. one to all), multicasting (i.e. one to many) or unicasting (i.e. one to one) and the invention should not be limited thereto. Note that in some embodiments of the invention, there may be more than one provider existing within the file sharing system. The client may determine the access of files from one provider, or from multiple providers having the same files, and the invention is not limited to either cases. When the client determines to access files from multiple providers having the same files, the data access request message 402 may also be transmitted to the providers by broadcasting, multicasting or unicasting. The concepts of broadcasting/multicasting/unicasting the data access request message 402 are similar to those of the file sharing message 401 as introduced above, and are omitted here for brevity.

In addition, according to some embodiments of the invention, the provider may also receive the data access request message 402 from different clients, and determine whether to transmit the selected file(s) by directly unicasting the selected file(s), or by multicasting the selected file(s) to multiple clients when they have selected the same file(s). For example, the provider may receive a first data access request message comprising information pertinent to one or more file(s) selected by a first client and a second data access request message comprising information pertinent to one or more file(s) selected by a second client. The provider may further determine whether the file(s) selected by the second client is/are the same as the file(s) selected by the first client. When there is any file selected by the second client which is the same as the file selected by the first client, the provider may determine a multicast group for transmitting the file, inform the first and second clients of the multicast address corresponding to a multicast group for receiving the file, and transmit the file to the multicast address. The concepts of multicasting/unicasting the content of the selected file(s) are similar to those of the file sharing message 401 as introduced above, and are omitted here for brevity.

According to the embodiments of the invention, by establishing a peer to peer group connection between the provider(s) and the client(s), the content of the selected file(s) may be multicast to different clients, instead of individually being unicast to different clients, and the transmission bandwidth can be greatly saved.

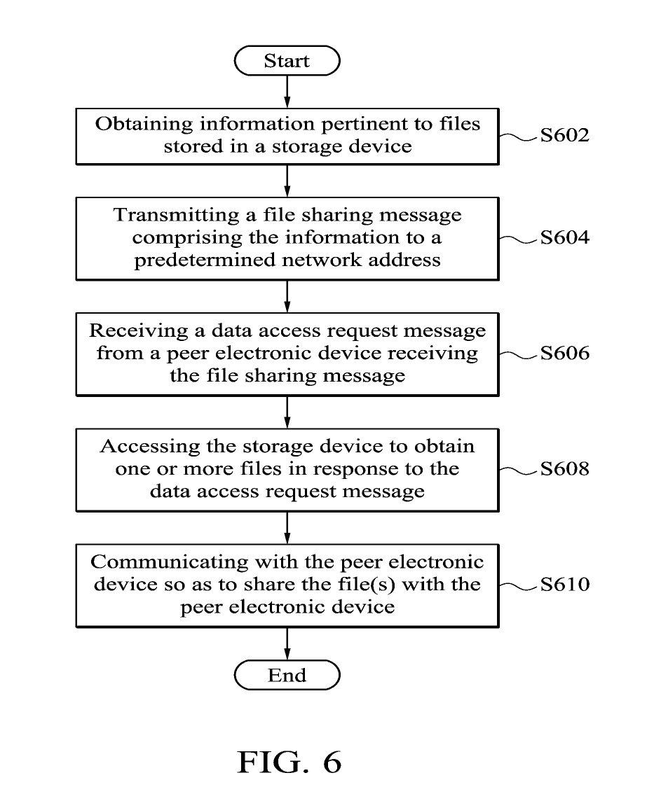

FIG. 6 shows a flow chart of a file sharing method according to an embodiment of the invention. In the embodiment, the provider in a file sharing system may first obtain information pertinent to a plurality of files stored in a storage device (step S602). As previously described, data size of the information is much smaller than data size of the files. Next, the provider may transmit a file sharing message comprising the information to a predetermined network address (step S604). Upon receiving a data access request message from a peer electronic device receiving the file sharing message (step S606), the provider may access the storage device to obtain one or more files in response to the data access request message (step S608) and communicate with the peer electronic device so as to share the file(s) with the peer electronic device (step S610).

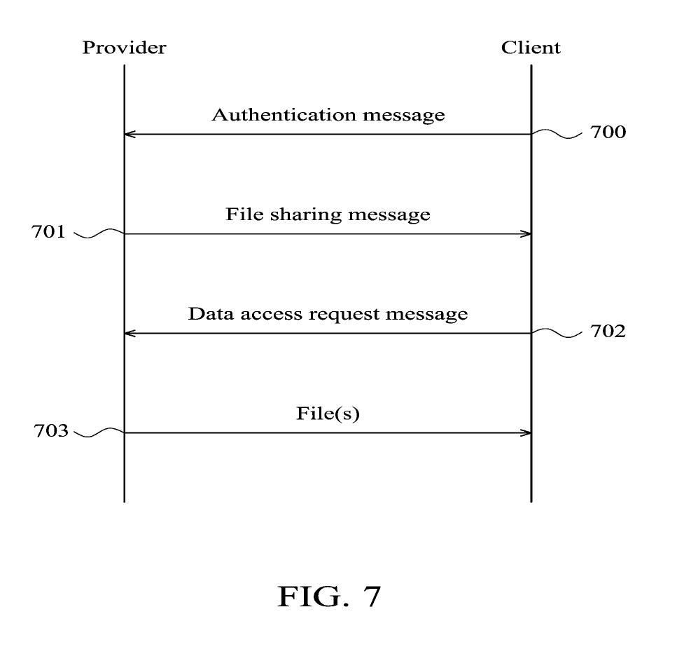

According to another embodiment of the invention, an authentication procedure may be introduced prior to the transmission of the file sharing message. FIG. 7 shows a message and data flow between a provider and a client according to another embodiment of the invention. As shown in FIG. 7, the client may first transmit an authentication message 700 comprising information pertinent to the identity of the client to the provider. The provider may maintain an authorized client list comprising identity(ies) of one or more authorized client(s) that is/are given the right to access the file(s) stored in the storage device 100. After authenticating the client (for example, after confirming that the identity of the client is in the authorized client list), the provider may transmit a file sharing message 701 comprising the information pertinent to the files stored in the assigned sharing folders to the predetermined network address in the local area network or to the client. As previously described, the information pertinent to the files stored in the assigned sharing folders may comprise file names of the files, and/or directories of the assigned sharing folder(s). In addition, information pertinent to establishment of the peer to peer or peer to peer group connection that is to be established between the client and the provider may also be carried in the file sharing message 701. The information pertinent to establishment of the peer to peer or peer to peer group connection may comprise the IP address of the provider, the connection type (for example, Wifi, WiFi-direct, Bluetooth, UPnP, UMTS, or others), or any connection protocol related information.

When the clients having the file-sharing application program installed therein have received the file sharing message 701, the clients may determine or select one or more of the files which they would like to access based on the information carried in the file sharing message 701, and generate a data access request message 702 comprising the information pertinent to the one or more selected file(s). The data access request message 702 may be transmitted back to the provider. Upon receiving the data access request message 702, the provider may access the one or more selected file(s) in response to the data access request message 702, and communicate with the client so as to share the selected file(s) 403 with the client. Detailed embodiments for broadcasting, multicasting, or unicasting the file sharing message and for establishing the peer to peer or peer to peer group connection have been introduced above and are omitted here for brevity.

According to a first embodiment of the invention, the provider may authenticate the client via a short distance connection. For example, as the distance of a client electronic device is positioned close enough to the provider, a short distance connection may be established between the provider and the client and the authentication message 700 may be transmitted therebetween for authentication. Upon completion of the authentication, the file sharing message 701 may be transmitted to the client via the peer to peer or peer to peer group connection established in compliance with the WiFi, WiFi-direct, Bluetooth, UPnP or UMTS protocol as previously described. According to a second embodiment of the invention, after authentication, the provider may further transmit the file sharing message 701 to the client via the short distance connection. The short distance connection may be, for example and not limited to, established in accordance with a near field communication (NFC) communication protocol.

The Near Field Communication or NFC is a short-range high frequency wireless communication technology which enables the exchange of data between devices over about a 10 centimeters (around 4 inches) distance. The technology is a simple extension of the ISO/IEC 14443 proximity-card standard (contactless card, RFID). As the client electronic device equipped with an NFC enabled tag or an NFC controller or the likes is positioned close enough to the provider electronic device which is also equipped with an NFC enabled tag or an NFC controller or the likes, the provider electronic device may detect the existence of the client electronic device and establish the near field communication with the client electronic device. Note that the establishment of near field communication may also be initiated or triggered by the client electronic device, and the invention should not be limited thereto.

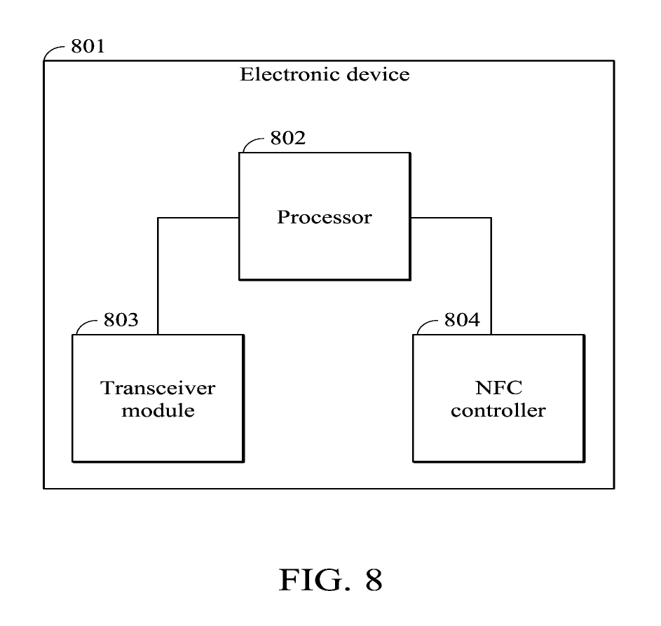

FIG. 8 shows a block diagram of an electronic device in a file sharing system according to another embodiment of the invention. The electronic device 801 may be either a provider electronic device (when being coupled to the storage device 100) or a client electronic device, and may comprise a processor 802, a transceiver module 803 and an NFC controller 803. The processor 802 may execute the above-mentioned file-sharing application program, control operations of the transceiver module 803 and the NFC controller 803 and, when being coupled to the storage device 100, identify the identity of the client and obtain information pertinent to and access the file(s) stored in the storage device 100. The transceiver module 803 may be a transceiver module capable of establishing long distance connection (as compared to the short distance NFC), such as a Wifi, WiFi-direct, Bluetooth, or UMTS transceiver module, or others, for transceiving signals in compliance with the corresponding communication protocol. The NFC controller 804 may be an NFC chip, an NFC circuit, or an NFC processor logic accompanied with an antenna coil, or the likes.

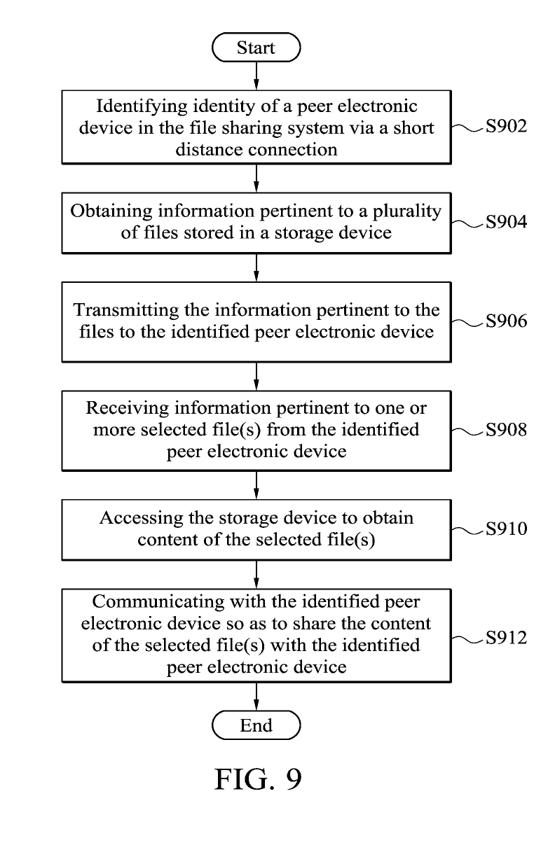

FIG. 9 shows a flow chart of a file sharing method according to another embodiment of the invention. In the embodiment, the provider in a file sharing system may first identifying identity of a peer electronic device in the file sharing system via a short distance connection, which is established between the provider electronic device and the peer (i.e. client) electronic device as previously described (Step S902). Next, the provider may obtain information pertinent to a plurality of files stored in a storage device (step S904). Next, the provider may transmit the information pertinent to the files to the identified peer electronic device, which has been identified in step S902 (Step S906). As previously described, the information pertinent to the files may be transmitted via either the short distance connection or the peer to peer or peer to peer group connection established in compliance with the corresponding communication protocol. Next, the provider may receive information pertinent to one or more selected file(s) from the identified peer electronic device (Step S908). Next, the provider may access the storage device to obtain content of the selected file(s) (Step S910). Finally, the provider may communicate with the identified peer electronic device so as to share the content of the selected file(s) with the identified peer electronic device (Step S912).

The file sharing method as described above, or certain aspects or portions thereof, may take the form of a program code (i.e., executable instructions), such as the above-mentioned file-sharing application program, embodied in tangible media, such as floppy diskettes, CD-ROMS, hard drives, or any other machine-readable storage medium, wherein, when the program code is loaded into and executed by a machine or an electronic device, such as a computer, a cell phone, or other, and the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, a cell phone, or other, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device in a file sharing system, comprising:
a processor, identifying a peer electronic device in the file sharing system based on an authentication message carrying information pertinent to identity of the peer electronic device and obtaining information pertinent to one or more file(s) stored in a storage device;
a short distance communication controller, receiving the authentication message; and
a transceiver module, transmitting the information pertinent to the file(s) to the identified peer electronic device.

2. The electronic device as claimed in claim 1, wherein the short distance communication controller is a near field communication (NFC) controller capable of establishing a connection in accordance with an NFC communication protocol.

3. The electronic device as claimed in claim 1, wherein the transceiver module is a Wifi, WiFi-direct, Bluetooth, or UMTS transceiver module.

4. The electronic device as claimed in claim 1, wherein the information pertinent to the files comprises directories, folders and/or file names of the files.

5. The electronic device as claimed in claim 1, wherein the transceiver module further receives information pertinent to one or more selected file(s) from the identified peer electronic device receiving the information pertinent to the file(s), and transmits content of the one or more selected file(s) to the identified peer electronic device.

6. An electronic device in a file sharing system, comprising:
a processor, identifying a peer electronic device in the file sharing system based on an authentication message carrying information pertinent to identity of the peer electronic device and obtaining information pertinent to one or more file(s) stored in a storage device;
a short distance communication controller, receiving the authentication message and transmitting the information pertinent to the file(s) to the identified peer electronic device; and
a transceiver module, transmitting content of the file(s) to the identified peer electronic device.

7. The electronic device as claimed in claim 6, wherein the short distance communication controller is a near field communication (NFC) controller capable of establishing a connection in accordance with an NFC communication protocol.

8. The electronic device as claimed in claim 6, wherein the transceiver module is a Wifi, WiFi-direct, Bluetooth, or UMTS transceiver module.

9. The electronic device as claimed in claim 6, wherein the information pertinent to the files comprises directories, folders and/or file names of the files.

10. The electronic device as claimed in claim 6, wherein the transceiver module further receives information pertinent to one or more selected file(s) from the identified peer electronic device receiving the information pertinent to the file(s), and transmits content of the one or more selected file(s) to the identified peer electronic device.

11. A file sharing method, comprising:
identifying, by an electronic device, identity of a peer electronic device in a file sharing system via a short distance connection established between the electronic device and the peer electronic device;
obtaining, by the electronic device, information pertinent to a plurality of files stored in a storage device, wherein data size of the information is smaller than data size of the files;
transmitting, by the electronic device, the information pertinent to the files to the identified peer electronic device;
receiving, by the electronic device, information pertinent to one or more selected file(s) from the identified peer electronic device ;
accessing, by the electronic device, the storage device to obtain content of the selected file(s); and
communicating, by the electronic device, with the identified peer electronic device so as to share the content of the selected file(s) with the identified peer electronic device.

12. The method as claimed in claim 11, wherein the short distance connection is established in accordance with a near field communication protocol.

13. The method as claimed in claim 11, wherein the information pertinent to the files are transmitted via the short distance connection established in accordance with a near field communication protocol.

14. The method as claimed in claim 11, wherein the information pertinent to the files comprises directories, folders and/or file names of the files.

15. The method as claimed in claim 11, further comprising:
transmitting the content of the selected file(s) in accordance with a Wifi, WiFi-direct, Bluetooth, or UMTS communication protocol.

16. The method as claimed in claim 11, further comprising:
transmitting the information pertinent to the files and the content of the selected file(s) in accordance with a Wifi, WiFi-direct, Bluetooth, or UMTS communication protocol.
